(19) United States
(12) Patent Application Publication
(10) Pub. No.: US 2013/0022014 A1
(43) Pub. Date: Jan. 24, 2013

(54) METHOD AND APPARATUS FOR DETERMINING SEARCH SPACES AND SEARCH POSITIONS IN A COMMUNICATION SYSTEM WHICH OPERATES A PLURALITY OF COMPONENT CARRIERS, AND METHOD AND APPARATUS FOR DECODING CONTROL INFORMATION USING SAME

(71) Applicants: Sungkwon Hong, Seoul (KR); Kibum Kwon, Seoul (KR); Jae Hyun Ahn, Seoul (KR)

(72) Inventors: Sungkwon Hong, Seoul (KR); Kibum Kwon, Seoul (KR); Jae Hyun Ahn, Seoul (KR)

(73) Assignee: PANTECH CO., LTD., Seoul (KR)

(21) Appl. No.: 13/638,918

(22) PCT Filed: Mar. 31, 2011
(86) PCT No.: PCT/KR2011/002256

§ 371 Date: Oct. 1, 2012

(30) Foreign Application Priority Data
Apr. 2, 2010 (KR) 10-2010-0030305
May 28, 2010 (KR) 10-2010-0050400

(51) Int. Cl. H04W 72/04

(52) U.S. Cl. 370/329

(57) ABSTRACT

Aspects of the invention include a method and apparatus for allocating a control information resource in a wireless communication system, which operates a plurality of component carriers, and for decoding control information. Control information on the plurality of component carriers is realigned in accordance with the order of decoding and resources are allocated to reduce control information decoding complexity at the receiving end and to enable an estimation of amount of computation for decoding. A method for determining a search space, which is a set of physical downlink control channel (PDCCH) candidates to be monitored by a terminal in a communication system, involves determining, as the search space, an extended search candidate formed by the value obtained by multiplying the number of search candidates applied to a carrier component and carrier indication information on the component carriers of user equipment if the user equipment uses a plurality of component carriers.

### CROSS-REFERENCE TO RELATED APPLICATIONS

This application is the National Stage Entry of International Application No. PCT/KR2011/002256, filed on Mar. 31, 2011 and claims priority from and the benefit of Korean Patent Application Nos. 10-2010-0030305, filed on Apr. 2, 2010, and 10-2010-0050400, filed on May 28, 2010, all of which are hereby incorporated by reference for all purposes as if fully set forth herein.

### BACKGROUND

1. Field

The present invention relates to a control information resource allocation method and apparatus, and a control information decoding method and apparatus in a wireless communication system that operates a plurality of component carriers, and particularly, to a method and apparatus for rearranging control information associated with a plurality of component carriers in decoding order for resource allocation.

2. Discussion of the Background

As communication systems have developed, various wireless terminals have been utilized by consumers, such as companies and individuals.

A current mobile communication system may be a high capacity communication system capable of transmitting and receiving various data such as image data, wireless data, and the like, beyond providing a sound-based service. Accordingly, there is a desire for a technology that transmits high capacity data, which is comparable with a wired communication network. Also, the system is required to include an appropriate error detection scheme that minimizes loss of information and increases transmission efficiency of the system so as to enhance performance of the system.

In general, in a communication system, control information such as channel information may need to be transmitted to a counterpart apparatus. An uplink control channel, a downlink control channel, and the like may be used for the transmission. Although they are defined in a physical layer, this may not be limited thereto.

Unlike a current communication system that uses a single carrier, formed of a single frequency band, a recently discussed wireless communication system may consider a scheme that uses a plurality of component carriers (hereinafter referred to as a “component carrier” or “CC”).

Therefore, in the communication system that uses the plurality of component carriers, each component carrier may function as a single cell and thus, a UE may need to be informed of control information associated with each component carrier, and up-to-date system information may need to be transmitted to the UE. However, currently, the technology for the above has not been defined.

### SUMMARY

Therefore, the present invention has been made in view of the above-mentioned problems, and an aspect of the present invention is to provide a method and apparatus for allocating control information associated with a plurality of component carriers for resource allocation in a wireless communication system.

Another aspect of the present invention is to provide a method and apparatus for receiving control information associated with a plurality of component carriers and decoding the received control information in a wireless communication system.

Another aspect of the present invention is to provide a method and apparatus for rearranging control information associated with a plurality of component carriers in decoding order, and allocating the rearranged control information for resource allocation in a wireless communication system.

Another aspect of the present invention is to provide a method and apparatus for rearranging control information associated with a plurality of component carriers in decoding order and allocating the rearranged control information, so as to decrease the complexity of decoding.

Another aspect of the present invention is to provide a method and apparatus for rearranging control information associated with a plurality of component carriers in decoding order and allocating the rearranged control information, so as to enable a UE to perform prediction associated with decoding.

In accordance with an aspect of the present invention, there is provided a method of determining a search space for blind decoding of downlink control information by a receiving apparatus in a communication system that uses multiple component carriers, the method including: selecting a CC set including one or more component carriers to be used by the receiving apparatus; and determining, to be the search space, an extended search candidate formed by multiplying a number of one or more search candidates applied to a single carrier and a total number of component carriers used in the system.

In accordance with another aspect of the present invention, there is provided a method of determining a search position to which downlink control information is to be allocated in a search space for blind decoding of the downlink control information by a receiving apparatus in a communication system that uses multiple component carriers, the method including: selecting a CC set including one or more component carriers to be used by the receiving apparatus; determining, to be the search space, an extended search candidate formed by multiplying a number of one or more search candidates applied to a single carrier and a total number of component carriers used in the system; and successively determining a search position where downlink control information is to be located in the search space, by excluding a search position preoccupied (blocked) by another UE in the search space.

In accordance with another aspect of the present invention, there is provided a method of decoding control information in a communication system that uses multiple component carriers, the method including: receiving control information that is allocated to a search position selected from a search space formed by multiplying a number of one or more search candidates applied to a single carrier and a total number of component carriers used in a system, and is transmitted; performing blind decoding with respect to a predetermined resource search position in decoding order; and obtaining control information of each carrier.

In accordance with another aspect of the present invention, there is provided an apparatus for determining a search space for blind decoding of downlink control information by a receiving apparatus in a communication system that uses multiple component carriers, the apparatus including: a CC set determining unit to select a CC set including one or more component carriers to be used by the receiving apparatus; and a search space generating unit to generate the search space for blind decoding of downlink control information, wherein the search space generating unit determines, to be the search space, an extended search candidate formed by multiplying a number of one or more search candidates applied to a single carrier and a total number of component carriers used in the system.

In accordance with another aspect of the present invention, there is provided an apparatus for determining a search position to which downlink control information is to be allocated in a search space for blind decoding of the downlink control information by a receiving apparatus in a communication system that uses multiple component carriers, the apparatus including: a CC set determining unit to select a CC set including one or more component carriers to be used by the receiving apparatus; a search space generating unit to generate the search space for blind decoding of downlink control information; and a search position determining unit to determine one or more search positions extracted from the search space, wherein the search space generating unit determines, to be the search space, an extended search candidate formed by multiplying a number of one or more search candidates applied to a single carrier and a total number of component carriers used in the system; and the search position determining unit successively determines a search position to which downlink control information is to be located in the search space, by excluding a search position preoccupied (blocked) by another UE in the search space.

In accordance with another aspect of the present invention, there is provided an apparatus for decoding control information in a communication system that uses multiple component carriers, the apparatus including: a receiving unit to receive control information that is allocated to a search position selected from a search space formed by multiplying a number of one or more search candidates applied to a single carrier and a total number of component carriers used in the system, and is transmitted; and a decoding unit to obtain control information associated with a corresponding carrier by performing blind decoding with respect to a predetermined resource search position in decoding order.

In accordance with another aspect of the present invention, there is provided a method of allocating downlink control information to a resource space in a communication system that uses multiple component carriers, the method including: selecting a CC set including one or more component carriers to be used by a predetermined UE; determining a search space for blind decoding of downlink control information; determining one or more search positions extracted from the search space; and

rearranging downlink control information associated with at least a few of the component carriers included in the CC set and allocating the rearranged downlink control information to the plurality of search positions.

In accordance with another aspect of the present invention, there is provided a method of determining a search space that is a set of physical downlink control channel (PDCCH) candidates to be monitored by a user equipment in a communication system that uses multiple component carriers, the method including: when the user equipment uses the plurality of component carriers, determining, to be the search space, an extended search candidate formed by multiplying a number of one or more search candidates applied to a single carrier and carrier indication information of a component carrier formed in the user equipment.

### BRIEF DESCRIPTION OF THE DRAWINGS

FIG. 1 is a diagram illustrating an example of a system that uses a plurality of component carriers according to an embodiment of the present invention;

FIG. 2 is a flowchart illustrating a method of allocating control information according to an embodiment of the present invention;

FIG. 3 is a flowchart illustrating a method of decoding control information according to an embodiment of the present invention;

FIG. 4 is a diagram illustrating a configuration of a control information resource allocating apparatus according to an embodiment of the present invention;

FIG. 5 is a diagram illustrating an example of an configuration of an entire transmitting apparatus including a control information resource allocating apparatus according to an embodiment of the present invention; and

FIG. 6 is a diagram illustrating a configuration of a control information decoding apparatus according to an embodiment of the present invention.

### DETAILED DESCRIPTION OF THE ILLUSTRATED EMBODIMENT

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

The specifications will describe a wireless communication network, and operations performed in the wireless communication network may be performed in a process in which a system (for example, a base station) that manages the wireless communication network controls the network and transmits data, or may be performed in a user equipment coupled to the corresponding wireless network.

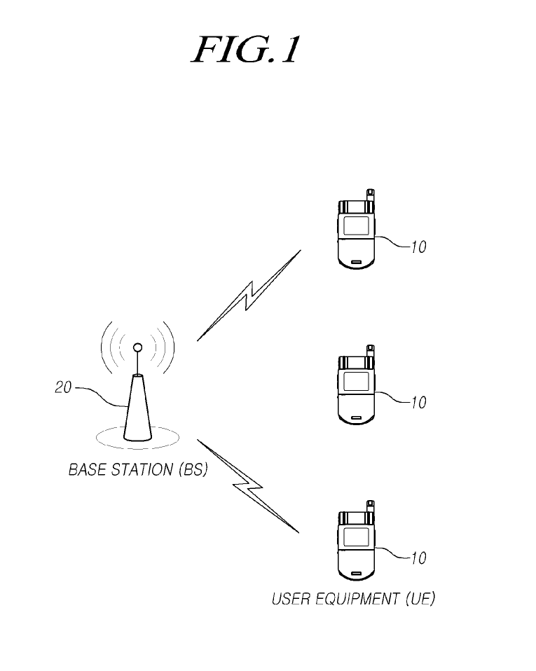

FIG. 1 illustrates a wireless communication system according to an embodiment of the present invention.

The wireless communication system may be widely installed so as to provide various communication services such as voice data, packet data, and the like.

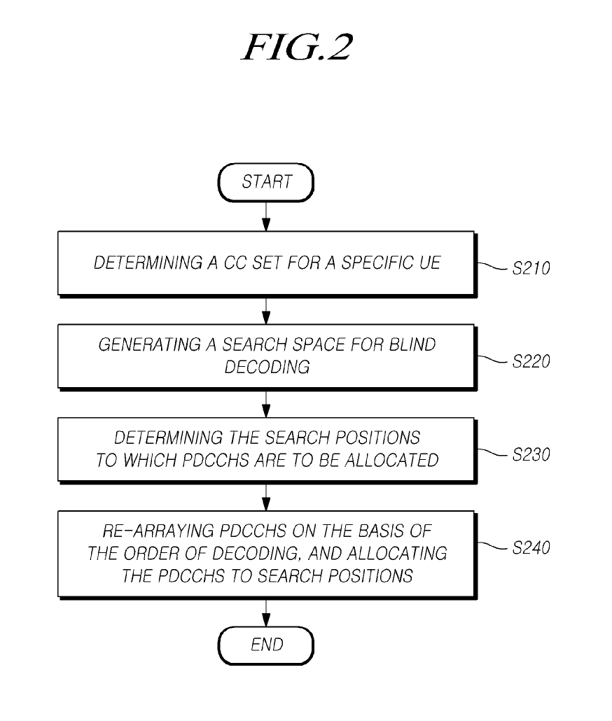

Referring to FIG. 1, the wireless communication system may include a User Equipment (UE) 10 and a Base Station (BS) 20. A component carrier-associated control information resource allocating technique may be applied to the UE 10 and the BS 20. The multiple component carriers-associated control information resource allocating method and apparatus will be described from the descriptions of FIG. 2.

The UE 10 may be an inclusive concept indicating a user terminal utilized in a wireless communication, including a User Equipment (UE) in WCDMA, LTE, HSPA, and the like, and a Mobile Station (MS), a User Terminal (UT), a Subscriber Station (SS), a wireless device and the like in GSM.

The base station 20 or a cell may refer to all devices, a function, or a predetermined area where communication with the user equipment 10 is performed, and may also be referred to as a Node-B, an evolved Node-B (eNB), a sector, a site, a Base Transceiver System (BTS), an Access Point, a relay node, and the like.

That is, the base station 20 or the cell may be construed as an inclusive concept indicating a function or a portion of an area covered by a NodeB in WCDMA, an eNB or a sector in LTE, and the like, and the concept may include various cell coverage areas, such as a megacell, a macrocell, a microcell, a picocell, a femtocell, a communication range of a relay node, and the like.

In the specifications, the user equipment 10 and the base station 20 are used as two inclusive transceiving subjects to embody the technology and technical concepts described in the specifications, and may not be limited to a predetermined term or word.

The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like.

Uplink transmission and downlink transmission may be performed based on a Time Division Duplex (TDD) scheme that performs transmission based on different times, or based on a Frequency Division Duplex (FDD) scheme that performs transmission based on different frequencies.

An embodiment of the present invention may be applicable to resource allocation in an asynchronous wireless communication scheme that is advanced through GSM, WCDMA, and HSPA, to be Long Term Evolution (LTE) and LTE-advanced, and may be applicable to resource allocation in a synchronous wireless communication scheme that is advanced through CDMA and CDMA-2000, to be UMB. Embodiments of the present invention may not be limited to a specific wireless communication scheme, and may be applicable to all technical fields to which a technical idea of the present invention is applicable.

The wireless communication system may support an uplink and/or downlink HARQ, and may use a channel quality indicator (CQI) for link adaptation. Also, a multiple access scheme for downlink transmission and a multiple access scheme for uplink transmission may be different from each other. For example, a downlink may use Orthogonal Frequency Division Multiple Access (OFMDA) and an uplink may use Single Carrier-Frequency Division Multiple Access (SC-FDMA).

Layers of a radio interface protocol between a UE and a network may be distinguished as a first layer (L1), a second layer (L2), and a third layer (L3), based on three lower layers of a well-known Open System Interconnection (OSI) model in a communication system, and a physical layer of the first layer may provide an information transfer service through use of a physical channel.

According to an embodiment of the present invention, in a wireless communication system, for example, a single radio frame may be formed of ten subframes and a single subframe may be formed of two slots.

A basic unit for data transmission may be a subframe, and uplink scheduling or downlink scheduling may be performed based on a subframe unit. A single slot may include a plurality of OFDM symbols in a time domain, and may include at least one subcarrier in a frequency domain, and a single slot may include 7 or 6 OFDM symbols.

For example, when a subframe is formed of two time-slots, each time-slot includes 7 symbols in a time domain and 12 subcarriers in a frequency domain. Although a time-frequency domain defined by a single slot as described in the foregoing may be referred to as a resource block (RB), it may not be limited thereto.

Each of lattices forming the resource block (RB) may be referred to as a resource element (hereinafter referred to as an “RE”), and 14×12=168 REs may exist in each subframe or a resource block based on the structure described in the foregoing.

A currently used communication system uses a single carrier having a predetermined frequency bandwidth (up to 20 MHz), and the wireless communication system may transmit and receive system information (SI) associated with a single component carrier (hereinafter referred to as a CC) through a corresponding CC.

However, a recently discussed new communication system has discussed extension of a bandwidth to satisfy required performance. In this example, a unit carrier that a communication user equipment may conventionally have may be defined to be a component carrier, and discussion about a scheme that binds one or more component carriers (for example, up to 5) is in progress.

That is, a plurality of component carriers of which a frequency band is 20 MHz may be bound and used. For example, 5 component carriers may be bound (a number of component carriers is not limited to 5 and N component carriers may be used, and a bandwidth of each component carrier may be changed) and thus, a bandwidth may be extended up to 100 MHz. A scheme that binds a plurality of component carriers to use an extended bandwidth may be referred to as carrier aggregation. A frequency band allocable through component carriers may be contiguous or non-contiguous.

Associated with the carrier aggregation, a plurality of component carriers may be classified, based on a characteristic, into three types, that is, a backwards compatible carrier, a non-backwards compatible carrier, and an extension carrier.

The backward compatible carrier (hereinafter referred to as a ‘backwards compatible carrier’ or a ‘BC’) is a carrier that is applicable to a UE of all existing LTE versions, and may operate as a single (sole) carrier or operate as a part of the carrier aggregation. In Frequency Division Duplex (FDD), the BC may exist as a pair of an uplink and a downlink.

The non-backwards compatibility carrier (hereinafter referred to as a ‘Non-backwards compatibility carrier’ or an ‘NBC’) is incapable of accessing a UE in an existing communication system. When the NBC is generated from a duplex distance, the NBC may operate as a single (sole) carrier. Otherwise, the NBC may operate as only a part of the carrier aggregation.

Also, the extension carrier (hereinafter referred to as an ‘extension carrier’ or an ‘ExC’) may not operate as a single (sole) carrier and may be used as a part of at least one component carrier set including a carrier that operates as a single carrier. The ExC may be used only for extending a bandwidth.

In a multiple component carrier environment, multiple component carriers (CC) that are capable of receiving a signal may be allocated to a UE, and the UE may need to obtain control information of each component carrier for appropriate operation of the plurality of allocated component carriers.

When only a single component carrier is used in a downlink such as a conventional LTE and the like, an eNB may transmit control information required for data transmission to the UE, through a physical downlink control channel (hereinafter referred to as a “PDCCH” or a “physical downlink control channel”). The PDCCH may include control information for various uplink and downlink transmissions, including information associated with uplink and downlink resource allocation for the UE and information associated with a transmission scheme. The PDCCH may have various types based on a downlink control information (DCI) format, which is a format for transmitting control information. A range of a DCI format of the PDCCH allowed in each transmission mode may be limited based on a transmission mode determined by an upper layer signaling, and may be transmitted to the UE. Also, the PDCCH may be transmitted to a predetermined UE, so as to transmit control information used for uplink and downlink communication of the predetermined UE and to transmit commonly used common information.

Although the UE is aware of information associated with a transmission mode, among information associated with the transmission of the PDCCH, the UE may not be aware of a DCI format to be used for the PDCCH transmission from among DCI formats available in the recognized transmission mode, and also may not be aware that the PDCCH is transmitted from which location in a control region of a subframe where the PDCCH is transmitted. The UE is scheduled dynamically based on a subframe unit, to maximally have the degree of freedom under the circumstance where the control region where the PDCCH is transmitted is shared by a plurality of UEs. Accordingly, the UE may need to extract control information allocated to the UE through blind decoding. The blind decoding may include a process of decoding all search positions determined based on an RNTI in a given transmission mode with respect to all available DCI formats, and a process of selecting a PDCCH determined to be control information of the UE through a CRC check. A CRC value may be masked to be a C-RNTI value, and the C-RNTI may be allocated for each UE and may be distinguished.

A search position in the control region on which the UE performs blind decoding, that is, a set of PDCCH candidates to be monitored by the UE, may be referred to as a search space, and the search space may be determined based on Equation 1.

A control channel element (hereinafter referred to as a “CCE”) corresponding to a PDCCH candidate m of a search space Sₖ^{(L)} of which an aggregation level is Lε{1,2,4,8} may be expressed as follows.

Sₖ^{(L)}=L·{(Yₖ+m)mod └N_{CCE,k}/L┘}+i[Equation 1]

The CCE (control channel element) may be a basic unit for forming a control region, and a PDCCH may form a region by coupling a few CCEs. A number of coupled CCEs may be defined to be the aggregation level. The aggregation level may have, for example, four values such as 1, 2, 4, and 8, but it may not be limited thereto. A location in the control region may be expressed through use of the CCE as a basic unit. A location of Sₖ^{(L)} may be determined through use of the CCE as a basic unit. i=0, . . . , and L−1 may be a constant, and may have a range of m=0, . . . , M^{(L)}−1. M^{(L)} denotes a number of search candidates to be checked in the search space. N_{CCE,k} denotes a number of available CCEs in a subframe number k. The control region may be N_{CCE,k}−1 at 0, and a number may be assigned based on a CCE unit.

Yₖ in Equation 1 may be expressed as given in Equation 2.

Yₖ=(A·Yₖ₋₁)mod D [Equation 2]

Here, Y₋₁=n_{RNTI}≠0, A=39827, D=65537, and k=└nₛ/2┘. nₛ denotes a slot number in a frame. Therefore, k denotes a subframe number. n_{RNTI} denotes an RNTI value.

The search space Sₖ^{(L)} may be determined based on Equation 1 and Equation 2, and search candidates determined by the standard may be arranged in the following table.

| Search space Sₖ^{(L)} | | | Number of PDCCH |
|---|---|---|---|
| Type | Aggregation level L | Size [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

The table includes UE-specific search candidates and search candidates associated with a common space. For the common space candidates, a value Yₖ of may be 0.

As described in the foregoing, a currently discussed next generation communication system discusses the carrier aggregation and a new design for a search space associated with the carrier aggregation. Configuring a search space of control information associated with a plurality of component carriers in the carrier aggregation environment may be expressed by Equation 3.

Yₖ=(A(Yₖ₋₁+f(n_{CI})))mod D [Equation 3]

f(n_{CI}) denotes a function determined by n_{CI} and n_{CI} denotes a carrier indicator. Although n_{CI} is assumed to have a value in a range from 0 through 4, it may not be limited thereto and the carrier indicator may have other values. The carrier indicator may indicate a component carrier from among available component carrier(s), for example, a number assigned to each component carrier, and may be a concept identical to a carrier indicator field (CIF).

In the specifications, large or small of the carrier indicator and high or low of the carrier indicator may be directed to the same meaning. When the carrier indication is high, the carrier indicator has a relatively a large value, and a descending order and an ascending order may indicate a serration based on a size of the carrier indicator.

Based on a control information transmission scheme described with reference to Equation 1 and Equation 2, a maximum number of blind decodings to be performed in the UE is 44. That is, (6+6+2+2)*2=32 UE-specific space blind decodings and (4+2)*2=12 common space blind decodings are assumed.

Here, the number is doubled since two sizes of the PDCCH are considered in each transmission mode. In a communication system that employs the carrier aggregation as described in the foregoing, two or more sizes may be considered since new schemes such as uplink multiple input-multiple output (MIMO) antenna techniques are introduced.

In the specifications, 44 blind decodings may be defined to be a 1 unit blind decoding process or a decoding process. The maximum number of blind decodings may be an important factor to determine the complexity of decoding and power consumption in the UE and thus, the number of blind decodings needs to be designed to have a small value.

When a maximum number of carriers considered for the carrier aggregation is 5, an amount of communication between the UE and the eNB may be increased up to fivefold by considering the 5 carriers, and an amount of transmission of control information may be predicted to be increased up to fivefold. Therefore, a number of blind decodings may be increased up to fivefold equal to a level of 44*5=220.

Therefore, in the multiple component carrier environment, the complexity of the blind decoding for obtaining control information in the UE may need to be minimized.

According to an embodiment of the present invention, allocating physical downlink control information to a resource space in the communication system that uses multiple component carriers may include a process of selecting a CC set including a plurality of component carriers to be used by a predetermined UE, a process of determining a search space for blind decoding of downlink control information, a process of determining a plurality of search positions extracted from the search space, and a process of rearranging downlink control information associated with the plurality of component carriers included in the CC set and allocating the rearranged downlink control information to the plurality of search positions.

Here, the rearrangement may allocate downlink control information of a CC having the highest carrier indicator to a search position of which a blind decoding order is the highest from among the plurality of search positions, but this may not be limited thereto.

That is, a carrier indicator of downlink control information allocated in the decoding order of the search positions may be arranged in descending order.

Also, the plurality of search positions to which the downlink control information is to allocated may be determined based on a first scheme that selects one or more search positions from a search space corresponding to a search candidate (group) determined based on a function associated with a carrier indicator, and a second scheme that selects one or more search positions from an extended search position candidate (group) formed by multiplying one or more search positions applied to a single carrier and a total number of component carriers used in a system.

In particular, the first scheme may include a (1-1) scheme that selects only a single search position from a plurality of search position candidates (group) in a search space determined by a single carrier indicator, and a (1-2) scheme that select two or more search positions from the plurality of search position candidates (group) corresponding to the search space determined by the single carrier indicator.

A search position determined by a lower carrier indicator from among a plurality of used component carriers may have an earlier decoding order. However, it may not be limited thereto, and the search position may have a decoding order determined based on an order of a physical position of a CCE or may have an arbitrary decoding order.

When the decoding order is determined based on the physical position of the CCE, the search position may have an earlier decoding order as a number of a CC corresponding to the search position is lower.

Also, from among a plurality of used component carriers, downlink control information of a primary CC may be allocated to a search position having the earliest decoding order, irrespective of large or small of the carrier indicator, but it may not be limited thereto.

That is, the downlink control information allocation method according to an embodiment of the present invention may be applicable to when the order of the blind decoding performed in the UE is determined based on an order of a physical position of a CCE or an arbitrarily determined order, in addition to when the order is determined to be an order of a carrier indicator (ascending order).

FIG. 2 is a flowchart illustrating a method of allocating control information according to an embodiment of the present invention.

Although embodiments of the present invention describe physical downlink control channel (PDCCH) information as an example of control information, this may not be limited thereto and the embodiments of the present invention may include all cases that allocate control information associated with a plurality of component carriers to a predetermined time/frequency resource space.

A control information allocating method of FIG. 2 is generally performed in a base station such as an eNB, but it may not be limited thereto.

First, the eNB may determine a CC set by selecting at least one component carrier that is to perform radio resource control connection with a UE (step S210).

That is, the eNB may allow the UE to use a plurality of component carriers (CC) by taking into consideration the performance of hardware of the corresponding UE, available frequency resources of the eNB, and the like, and may define the plurality of component carriers to be a set or a CC set.

When a CC set to be used by a predetermined UE is determined, the following schemes may be used but this may not be limited thereto.

A component carrier that is appropriate for attempting radio resource control connection may be selected based on measurement information measured by the UE, or radio resource control connection may be performed through use of information that is fixedly set by a system, stored in an internal memory of the UE. Also, the radio resource control connection may be performed through use of information transmitted to the UE from the eNB through system information. The CC set may be determined based on system information of available component carriers stored in the internal memory of the UE.

Subsequently, a search space for blind decoding of downlink control information may be determined (step S220).

The search space may include a plurality of search position candidates formed of location(s) of a time/frequency resource region or CCE(s), and the search space may be generated to correspond to one or more component carriers included in the CC set.

That is, the search space may be determined based on a function associated with carrier indicators of one or more CCs from among the plurality of CCs to be used by the UE, but it may not be limited thereto.

It is assumed that search position candidates corresponding to a single carrier for carrier aggregation (CA), that is, the search space is given as Sₖ^{(l)}{S₀, S₁, . . . , S_{Q-1}}, and a blind decoding order in a receiving end of the UE is S₀→S₁→S₂ . . . S_{Q-2}→S_{Q-1}.

In this example, values of S₀, S₁, . . . , S_{Q-1} are determined to be resource regions that may not overlap each other, and may be changed based on a design determined through discussion from the standardization.

Subsequently, the eNB may determine a plurality of search positions to which PDCCH information is to be actually allocated, from the search space formed of the plurality of search position candidates (step S230).

In this example, when the eNB determines a predetermined number of search positions to which the PDCCH information is to be actually allocated from among the plurality of search position candidates, the UE may preferentially select a search position candidate having an earlier blind decoding order, but this may not be limited thereto.

That is, under the assumption, a search position Pₖ^{(l)} to which a PDCCH is to be allocated may be determined by Equation 4, based on the decoding order of S₀→S₁→S₂ . . . S_{Q-2}→S_{Q-1} in the search space of Sₖ^{(l)}{S₀, S₁, . . . , S_{Q-1}}.

Pₖ^{(l)}={p₀,p₁,p₁, . . . , p_{R-1}}⊂Sₖ^{(l)} [Equation 4]

p₀, p₁, . . . , p_{R-1} are based on the order of S₀→S₁→S₂ . . . S_{Q-2}→S_{Q-1}. In this example, R denotes a number of carriers that are allocated by the eNB to the UE for use and are recognized by the UE, that is, the number of CCs included in the CC set.

When the search position is determined, the determining method may not be limited to the above method. The determining method may include a first scheme that selects one or more search positions from the search space corresponding to a search position candidate (group) determined based on a function associated with a carrier indicator, and a second scheme that selects one or more search positions from an extended search position candidate (group) formed by multiplying one or more search positions applied to a single carrier and a total number of component carriers used in a system. The first scheme may include a (1-1) scheme that selects a single search position from a plurality of search position candidates (group) in the search space determined by a single carrier indicator, and a (1-2) scheme that selects two or more search positions from the plurality of search position candidates (group) corresponding to the search space determined by the single carrier indicator, but this may not be limited thereto.

Various schemes of determining a search position will be described in detail later.

Subsequently, downlink control information associated with the plurality of CCs included in the CC set may be rearranged and the rearranged control information may be allocated to the plurality of search positions (step S240).

In this example, the rearrangement may enable downlink control information of a CC having the highest carrier identifier to be allocated to a search position having the earliest blind decoding order from among the plurality of search positions.

In the example, when it is assumed that the search positions to which PDCCHs are determined to be allocated are p₀, p₁, . . . , p_{R-1}, and the allocated PDCCHs correspond to {PDCCH_{k,CI}_{₀}^{l}, PDCCH_{k,CI}_{₁}^{l}, . . . , PDCCH_{k,CI}_{_{R−1}}^{l}}, they may match as given in Equation 5.

$$\begin{matrix}{p}_{0} ↔ {PDCCH}_{k , {CI}_{0}}^{l} \\ {p}_{1} ↔ {PDCCH}_{k , {CI}_{1}}^{l} \\ … \\ {p}_{R - 1} ↔ {PDCCH}_{k , {CI}_{R - 1}}^{l}\end{matrix} \qquad [ Equation 5 ]$$

That is, based on Equation 5, it may indicate that PDCCH_{k,CI}_{₀}^{l}, PDCCH_{k,CI}_{₁}^{l}, . . . , PDCCH_{k,CI}_{_{R−1}}^{l} located in the search positions p₀, p₁, . . . , p_{R-1}, respectively. Here, CIᵣ denotes carrier indicator information included in a PDCCH, and may have a value selected from 0 through 4.

In this example, in step S240, PDCCH_{k,CI}_{₀}^{l}, PDCCH_{k,CI}_{₁}^{l}, . . . , PDCCH_{k,CI}_{_{R−1}}^{l} may be rearranged to PDCCH_{k,CI′}_{₀}^{l}, PDCCH_{k,CI′}_{₁}^{l}, . . . , PDCCH_{k,CI}_{_{R−1}}^{l}′, and the rearrangement may be performed so that the order of the carrier indicators CI₀′, CI₁′, . . . , CI_{R-1}′ has the relationship of Equation 6.

CI₀′>CI₁′> . . . >CI_{R-2}′>CI_{R-1}′ [Equation 6]

That is, the PDCCH information may be rearranged so that control information having a higher carrier indicator is allocated to a search position having an earlier decoding order, as shown in Equation 6.

Therefore, Equation 7 may be obtained after the rearrangement.

$$\begin{matrix}{p}_{0} ↔ {PDCCH}_{k , {CI}_{0}^{′}}^{l} \\ {p}_{1} ↔ {PDCCH}_{k , {CI}_{1}^{′}}^{l} \\ … \\ {p}_{R - 1} ↔ {PDCCH}_{k , {CI}_{R - 1}^{′}}^{l}\end{matrix} \qquad [ Equation 7 ]$$

Although all PDCCHs to be transmitted are rearranged in the examples of Equations 5 through 7, this may not be limited thereto, and a few PDCCHs may be rearranged as shown in Equation 8. This may be applicable to an embodiment that enables a PDCCH associated with a primary carrier, a predetermined component carrier, or a predetermined component carrier set to be decoded first.

CI′ᵣ₁>CI′ᵣ₁₊₁> . . . >CI′ᵣ₂₋₁>CI′_{R2} [Equation 8]

Here, r2−r1 denotes a number of the few rearranged PDCCHs, and may have a value smaller than R corresponding to the total number of PDCCHs to be transmitted. In this example, the primary component carrier, the predetermined component carrier, or the predetermined component carrier set may be preferentially arranged in the decoding order to precede or follow physical control channels corresponding to remaining CCs.

Hereinafter, a PDCCH allocation scheme according to another embodiment of the present invention will be described.

Although an inclusive method for determining a search position based on a carrier indicator has been described, the search position may be determined based on the following embodiment.

In a search space forming method used in a conventional communication system, such as LTE, an extending scheme may be used excluding a term for the carrier indicator from a relational express associated with the search space.

As an example, the search space may be formed by extending a value of M^{(L)} that indicates a number of search position candidates. For example, the value of M^{(L)} when L=1 may be extended to less than or equal to a value obtained by multiplying the original value by a number of used carriers.

That is, when M^{(L)}=6 and 3 carriers (for example, carriers corresponding to indicators 0, 1, and 4) are determined to be used, the value may be extended to M^{(L)}=18(=6*3) and thus, the search space associated with the carrier aggregation may be extended. In this example, when L=1, N_{CCE,k}=80, and Y₋₁=n_{RNTI}=12345, and it is assumed that the search space associated with a plurality of component carriers is limited to a single CC, Sₖ^{(L)} may have search position candidates as shown in Equation 9.

Sₖ⁽¹⁾→61, 62, 63, 64, 65, 66, . . . (increase by 1) . . . , 77, 78 (a total of 18) [Equation 9]

That is, when the search space associated with the plurality of component carriers is determined as given in Equation 9, a CCE extended to a value obtained by multiplying carrier indicator information (n_{CI} which is a carrier indicator field and the like) of a plurality of (I) corresponding CCs from a predetermined position (m of Equation 1) and M^{(L)} indicating a number of search position candidates of a single component carrier, may be formed to be the search space. Also, as given in Equation 9, the search space associated with the plurality of component carriers may be extended to successively configured CCEs.

In other words, to extend the search space, the search space Sₖ^{(L)} may be determined through use of m+M^{(L)}·n_{CI} as opposed to using m in Equation 1.

In this example, it is assumed that search position candidates as shown in Equation 10 may be selected for the corresponding UE after excluding a search position candidate allocated by another UE.

Sₖ⁽¹⁾→64, 66, 67, . . . (increase by 1) . . . , 77, 78 [Equation 10]

A number of carriers to transmit control information is 3 (CC0, CC1, and CC4) and thus, a search position Pₖ⁽¹⁾ to which the control information is to be allocated may be determined as given in Equation 11.

Pₖ⁽¹⁾→64, 66, 67 [Equation 11]

In this example, when a blind decoding order for control information of the UE is determined based on a physical CCE order, the PDCCHs may be rearranged based on Equation 12.

64←→PDCCH_{k,4}⁽¹⁾

66←→PDCCH_{k,1}⁽¹⁾

67←→PDCCH_{k,0}⁽¹⁾ [Equation 12]

That is, the rearrangement may be performed so that a PDCCH of a CC having a higher carrier indicator is allocated to a search position that is preferentially decoded.

Accordingly, the UE may have an advantage in that an amount of calculation of the blind decoding may be reduced.

That is, in the example of Equation 12, when the UE decodes a value of a carrier indicator into 4 at the first decoding, the UE may determine that blind decoding may be performed up to 4 more times, and when the UE decodes a value of a carrier indicator into 1 at the second blind decoding, the UE may determine that blind decoding may be performed up to one more time. Accordingly, the UE may need to perform blind decoding a total of 3 times.

When a process of rearranging and alignment described in the foregoing does not exist, the blind decoding process may be performed five times. That is, unlike the present embodiment, when a blind decoding is performed in the ascending order of carrier indicators, blind decoding may need to be performed five times including blind decoding for carrier indicators 1 through 4 after blind decoding performed on a PDCCH associated with an initial carrier 0. However, according to the present embodiment, a total of three times blind decoding may need to be performed and thus, a number of blind decodings to be performed may be reduced by two times.

Selecting a search position candidate and a search space associated with the carrier aggregation is currently discussed, and has not been defined by the standard.

The search space of the carrier aggregation may be distributed in a part or an entirety of a carrier section with respect to a predetermined UE, or may be distributed within a single carrier.

When the search space is formed within a single carrier, control information of another carrier that is different from the carrier that has the search space may be transmitted by taking into consideration cross-carrier scheduling, and embodiments of the present invention may be applied, irrespective of the distribution of the search space with respect to a carrier.

It is assumed that a search position candidate is determined as given in Equation 13, based on an arbitrary carrier search space determining scheme.

S_{k,n}_{_{CI}}^{(L)},n_{CI}=0, . . . , n_{CI,max}−1 [Equation 13]

Here, S_{k,n}_{_{CI}}^{(L)}, denotes a search position candidate group for each carrier n_{CI}, and n_{CI,max} denotes a number of all carriers allocated to a corresponding UE.

[1] The eNB may select, from the available search position candidates as given in Equation 13, a search position, that is, a search position P_{k,j}^{(L)} to which a PDCCH is to be actually allocated and transmitted, for each carrier through scheduling. The search positions selected for each carrier from among the search position candidate group S_{k,n}_{_{CI}}^{(L)} may be expressed as shown in Equation 14.

P_{k,j}^{(L)},j=0, . . . , n_{CI,select}−1 [Equation 14]

Selecting the search position P_{k,j}^{(L)} may be affected by PDCCH blocking. The PDCCH blocking may indicate a case in which a selected search candidate is already allocated by another UE and may not be allocated again. Therefore, n_{CI,select} may be smaller than n_{CI,max}. P_{k,j}^{(L)} may denote a final search position to which a PDCCH is to be transmitted, determined for each carrier based on all the described particulars.

The PDCCH to be transmitted may be expressed by Equation 15.

PDCCH_{k,p}^{(L)},p=0, . . . , n_{CI,PDCCH}−1 [Equation 15]

PDCCH_{k,p}^{(L)} denotes a PDCCH intended by the scheduler to be transmitted, and n_{CI,PDCCH} denotes a number of the PDCCHs.

The blind decoding for decoding control information may be performed in a receiving end (UE) in predetermined order. When a number of carriers is 1, the blind decoding is performed with respect to a given search space. However, when the number of carriers increases due to the carrier aggregation, a decoding order for control information of the carriers may need to be determined.

The blind decoding may be performed in the order of carrier indicator values (ascending order), or may be performed in the order of a physical position (physical CCE position) having the earliest P_{k,j}^{(L)} that is a position to which the PDCCH is actually allocated.

Also, the decoding order may be determined based on another carrier aggregation to be formed or the technology of LTEA. When there is no predetermined constraint condition, the UE may arbitrarily determine the decoding order.

In the present embodiment, when the UE performs decoding in a decoding order determined for each carrier, positions of physical downlink channels may be rearranged in the order that a carrier indicator corresponding to a physical downlink control channel (PDCCH) decoded by the blind decoding is decreased from the first blind decoding. Therefore, the UE may have an advantage in that an amount of calculation associated with decoding may be reduced.

When physical downlink control channels corresponding to predetermined carriers need to be preferentially decoded due to a predetermined reason, the physical downlink control channels of the corresponding carriers are arranged to have earlier decoding order, and then remaining carriers may be arranged based on the described rule.

To perform the rearrangement, it is desirable that an aggregation level (L) of each physical downlink control channel (PDCCH) is identical to one another. However, when the aggregation levels of the PDCCHs are different from each other, the rearrangement may be performed.

For example, when L=1, N_{CCE,k}=80, n_{CI,max}=5, i=0, f(n_{CI})=n_{CI}, and Y₋₁=n_{RNTI}=12345, and it is assumed that a search space associated with a plurality of carriers is limited to a single carrier, S_{k,n}_{_{CI}}^{(L)} may have search position candidates as given in Equation 16, based on Equation 1 and the like.

S_{k,0}⁽¹⁾→61, 62, 63, 64, 65, 66

S_{k,1}⁽¹⁾→48, 49, 50, 51, 52, 53

S_{k,2}⁽¹⁾→18, 19, 20, 21, 22, 23

S_{k,3}⁽¹⁾→5, 6, 7, 8, 9, 10,

S_{k,4}⁽¹⁾→55, 56, 57, 58 59, 60 [Equation 16]

Here, S_{k,n}_{_{CI}}^{(L)} denotes a search space generated by a carrier indicator n_{CI}, that is, search position candidates, and may be expressed by a corresponding CCE number.

In this example, when the (1-1) scheme that selects only a single search position from a search space corresponding to a single carrier is used to determine the search position to which the PDCCH is to be allocated, the search position to which the PDCCH is to be finally allocated may be determined based on Equation 17.

P_{k,0}^{(l)}=61,P_{k,1}^{(l)}=48P_{k,2}^{(l)}=22,P_{k,4}^{(l)}=55 [Equation 17]

In this example, when it is assumed that PDCCHs to be transmitted by the eNB to the corresponding UE are PDCCH_{k,0}⁽¹⁾ and PDCCH_{k,4}⁽¹⁾ since carriers to be used by the corresponding UE are two carriers, that is, CC0 and CC4, and it is also assumed that the receiving end of the UE performs blind decoding on the PDCCH information in the order of carrier indicators (ascending order) from a value of a carrier indicator 0, a PDCCH allocation position, that is, the search position, may be determined by Equation 18.

a search position P_{k,1}⁽¹⁾=48 to which PDCCH_{k,0}⁽¹⁾ is allocated

a search position P_{k,0}⁽¹⁾=61 to which PDCCH_{k,4}⁽¹⁾ is allocated [Equation 18]

That is, a PDCCH having a higher carrier indicator may be allocated to a search position that is decoded earlier as given in Equation 18.

In this example, when the UE decodes a value of a carrier indicator into 4 at the first decoding, the UE determines that the blind decoding process may be performed 4 more times and keep performing the blind decoding, and when the UE decodes a value of a carrier indicator into 0 at the second blind decoding, the UE determines that the blind decoding may not need to be performed any longer. Therefore, the UE may perform blind decoding two times, and may complete the blind decoding process, that is, a PDCCH obtaining process. When the rearrangement and alignment process does not exist, the UE may perform the blind decoding process five times.

An embodiment of the present invention may be applicable to a case in which compositions of values of j and p are identical in P_{k,j}^{(L)} and PDCCH_{k,p}^{(L)} as described in the foregoing embodiment, and may also be applicable to a case in which a composition range of a value of j and a composition range of a value of p are different from each other in P_{k,j}^{(L)} and PDCCH_{k,p}^{(L)} as below.

For example, when search positions selected from the search space generated by each carrier indicator are P_{k,0}⁽¹⁾=61, P_{k,1}⁽¹⁾=48, P_{k,2}⁽¹⁾=22, and P_{k,4}⁽¹⁾=55, and control information PDCCH_{k,2}⁽¹⁾ and PDCCH_{k,3}⁽¹⁾ of CC2 and CC3 need to be transmitted, allocation may be performed as given in Equation 19.

a position of P_{k,1}⁽¹⁾=48 of PDCCH_{k,2}⁽¹⁾

a position of P_{k,0}⁽¹⁾=61 of PDCCH_{k,3}⁽¹⁾ [Equation 19]

That is, the present embodiment may be applicable to when a carrier indicator used for generating the search space and for determining the search position is different from a carrier indicator of a PDCCH to be actually transmitted. In this example, the carrier indicator used for generating the search space and for determining the search position may be available for determining a decoding order.

In this example, a carrier indicator of 3 may be decoded at the first decoding, and a carrier indicator of 2 may be decoded at the second decoding, and only the third and fourth decoding processes may be performed further. A carrier indicator value of 2 may inform the UE that two more decoding may need to be performed and thus, the UE may reduce a number of blind decodings to be performed, which was to performed up to 5 times.

As described in the embodiment, when a search space is formed within a single carrier, the carrier with respect to the search space is formed may be determined for each UE, and the carrier may have a different meaning to each UE when compared to remaining carriers. In embodiments of the present invention, the carrier to which the search space is given may be defined to be a primary component carrier (PCC).

The PCC may perform a special function with respect to other carriers, and may be required to be decoded earlier than other carriers in consideration of the standardization in the future.

As an example, the primary component carrier may include information associated with other component carriers, such as additional information for cross-carrier scheduling, activation deactivation information, ACK/NACK information, DAI, blind decoding information, and the like.

In this example, it is desirable that the primary component carrier is located first in the decoding order. PDCCHs of other carriers may be arranged based on the described rearrangement.

For example, when it is assumed that available transmission positions are P_{k,0}⁽¹⁾=61, P_{k,1}⁽¹⁾=48, P_{k,2}⁽¹⁾=22, and P_{k,4}⁽¹⁾=55, PDCCH_{k,0}⁽¹⁾, PDCCH_{k,1}⁽¹⁾, and PDCCH_{k,3}⁽¹⁾ are to be transmitted, and CC1 is the primary component carrier (PCC) from among CC0, CC1, and CC3, PDCCHs may be allocated as shown in Equation 20. In general, assigning 0 as a number of the PCC is considered. The same scheme may be applicable to this and to a case in which a different number is assigned as described in the foregoing example.

a position of PDCCH_{k,1}⁽¹⁾→P_{k,0}⁽¹⁾=61

a position of PDCCH_{k,3}⁽¹⁾→P_{k,1}⁽¹⁾=48

a position of PDCCH_{k,0}⁽¹⁾→P_{k,2}⁽¹⁾=22 [Equation 20]

That is, a PDCCH of CC1, which is the PCC, may be allocated to P_{k,0}⁽¹⁾=61 that has the earliest decoding order, irrespectively of an order of carrier indicators, and PDCCHs of remaining carriers may be allocated so that the order of carrier indicators becomes an inverse order of the decoding order, that is, PDCCH_{k,3}⁽¹⁾ is allocated to P_{k,1}⁽¹⁾=48 corresponding to a search position that has the second decoding order, and PDCCH_{k,0}⁽¹⁾ is allocated to P_{k,2}⁽¹⁾=22 corresponding to a search position that has the third decoding order.

Although the foregoing embodiment describes the (1-1) scheme that determines one search position in a search space generated by a single carrier indicator, this may not be limited thereto, and may determine a plurality of search positions from the search space generated by the single carrier indicator as described below (the (1-2) scheme).

The conventional LTE standard uses a single carrier and assumes a single PDCCH for each UE, for a search candidate group S_{k,n}_{_{CI}}^{(L)}. However, in the case of carrier aggregation, a plurality of PDCCHs for each carrier with respect to a single UE may be assumed.

Therefore, the present embodiment may decrease the complexity of blind decoding by allocating a plurality of PDCCHs to the search position candidate group S_{k,n}_{_{CI}}^{(L)} for each carrier.

That is, the (1-2) scheme that selects a plurality of available PDCCH positions may be applicable, as opposed to a scheme that selects a single PDCCH position from among the search candidate group.

For example, the description will be provided by assuming a case in which search position candidates are formed as given in Equation 21, excluding (blocking) a search position allocated to another UE from among search space for each carrier, generated by carrier indicators 0 through 4.

S_{k,0}⁽¹⁾→61, 62, 63

S_{k,1}⁽¹⁾→48, 51, 52, 53

S_{k,2}⁽¹⁾→18, 19, 20, 21, 22, 23

S_{k,3}⁽¹⁾→5, 6, 7, 8, 10

S_{k,4}⁽¹⁾→56, 57, 58, 59, 60 [Equation 21]

In this example, when it is assumed that five PDCCHs, that is, PDCCH_{k,0}⁽¹⁾, PDCCH_{k,1}⁽¹⁾, PDCCH_{k,2}⁽¹⁾, PDCCH_{k,3}⁽¹⁾, and PDCCH_{k,4}⁽¹⁾ are to be allocated, PDCCH_{k,4}⁽¹⁾, PDCCH_{k,3}⁽¹⁾, and PDCCH_{k,2}⁽¹⁾ may be sequentially allocated to 61, 62, and 63 that are candidate (group) of S_{k,0}⁽¹⁾ based on the decoding order, and PDCCH_{k,1}⁽¹⁾ and PDCCH_{k,0}⁽¹⁾ may be sequentially allocated to 48 and 51 that are candidate (group) of S_{k,1}⁽¹⁾.

When the search position is determined as described in the foregoing, decoding of all carriers may be completed through the first and the second blind decoding processes under assumption that decoding is performed for each carrier when the UE performs receiving and decoding.

That is, only two search candidate groups from the five search candidate groups may be considered and thus, this may provide an effect that dramatically reduces the complexity. The effect may be different for each UE. For a predetermined UE, a PDCCH may be allocated to be near the end in the blind decoding order and thus, blind decoding needs to be performed many times. However, generally, the complexity of the decoding may be reduced based on an average effect of a plurality of UEs. Also, this may be effective when only a few UEs exist in a cell and a probability of PDCCH blocking among UEs is low.

Also, according to the embodiment, as an example of a method of utilizing the primary component carrier, when PDCCH decoding start position information corresponding to a position where a PDCCH of each UE appears first is reported through a dedicated channel (physical downlink control channel or a upper layer signaling) of the primary component carrier, the complexity of decoding may be reduced with respect to UEs of which PDCCH positions for the blind decoding process are located near to end. In this example, the UE may start blind decoding from the received PDCCH decoding start position.

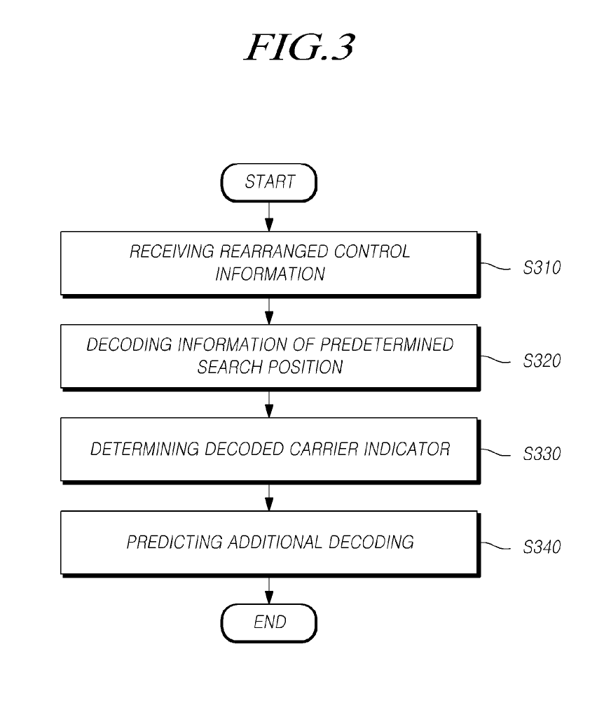

FIG. 3 is a flowchart illustrating a method of decoding control information according to an embodiment of the present invention.

The control information decoding method of FIG. 3 may be embodied in a receiving end such as a UE, but it may not be limited thereto.

The control information decoding method of FIG. 3 may be applicable to a communication system that uses multiple component carriers, and may include a step of receiving control information that is transmitted after being rearranged based on a decoding order (step S310), a step of performing blind decoding with respect to a predetermined resource search position in blind decoding order (step S320), a step of determining a carrier indicator of the decoded control information (step S330), and a step of predicting a number of carrier control information to be additionally obtained, based on the carrier indicator of the decoded control information (step S340).

As described in the foregoing, step S310 is a process of receiving a signal of which carrier control information is rearranged so that an order of carrier indicators becomes an inverse order of the blind decoding order of the control information at the receiving end. In this example, a search position where the carrier control information is located may be determined from a search space for each carrier, but it may not be limited thereto.

Also, control information of all carrier indicators transmitted in step S310 may not need to be rearranged in an inverse order, and a few carriers (for example, a primary carrier) may be preferentially arranged.

Subsequently, the UE may perform blind decoding of the received control information (PDCCH) from a predetermined search position in a predetermined decoding order (step S320). In this example, the decoding order may be an order of search positions determined for each carrier (ascending order of carrier indicators), a physical order of search positions (an order of CCE numbers), an arbitrarily determined order, or an order predetermined by a separate signaling or predetermined definition, but it may not be limited thereto.

In step S330, a carrier that corresponds to the decoded control information may be determined. A carrier indicator of the corresponding carrier may be included in the decoded control information or PDCCH. In this example, the carrier indicator corresponding to the decoded control information may be recognized by determining the carrier indicator.

In step S340, a number of carrier control information to be additionally obtained may be predicated based on the carrier indicator of the decoded control information. As described in the foregoing, when control information of a carrier having a higher indicator is allocated to a search position having an earlier decoding order, a number of carrier control information to be additionally decoded may be predicted by determining a corresponding carrier indicator of a currently decoded control information. For example, when control information decoded at the first decoding is control information associated with CC1, control information decoding with respect to CC0 may need to be performed, that is, the blind decoding process may be predicted to be performed one more time.

When a primary carrier is preferentially arranged in step S340, a number of remaining blind decodings to be performed may be predicted by taking into consideration the situation.

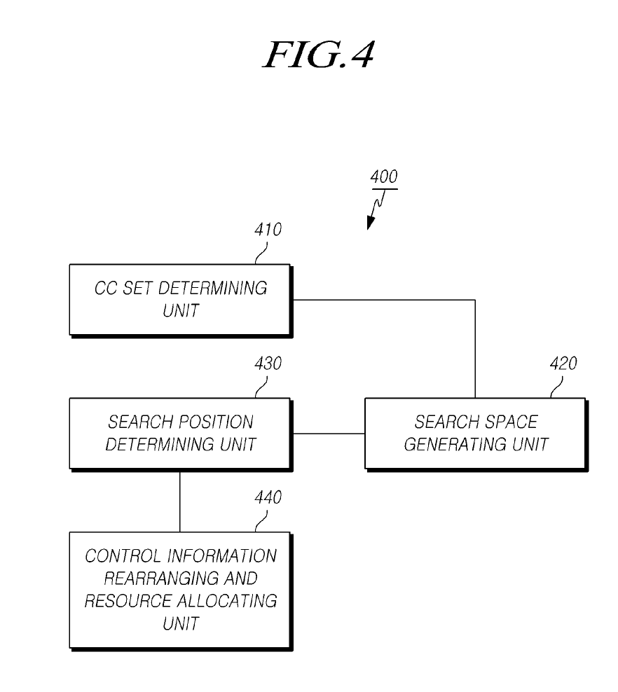

FIG. 4 is a diagram illustrating a configuration of a control information resource allocating apparatus according to an embodiment of the present invention.

In general, the control information resource allocating apparatus of FIG. 4 may be embodied in a base station such as an eNB. However, when control information corresponds to uplink control information and the like, the apparatus may be embodied in a UE.

A control information resource allocating apparatus 400 of FIG. 4 may be used in a communication system that uses multiple component carriers, and may be configured to include a CC set determining unit 410, a search space generating unit 420, a search position determining unit 430, a control information rearranging and resource allocating unit 440, and the like. When an embodiment of the present invention is used as a search space determining apparatus and a search position determining apparatus, the apparatus may be embodied without the search position determining unit 430 and the control information rearranging and resource allocating unit 440 from among the component elements.

It is desirable that the control information resource allocating apparatus 400 of FIG. 4 is used as an apparatus that allocates physical downlink control channel (PDCCH) information to a predetermined location of a time/frequency resource space, but it may not be limited thereto. The apparatus may be construed as an inclusive concept including all apparatuses that allocate any control information distinguished for each of multiple component carriers to a resource and transmit the control information.

The CC set determining unit 410 may perform a function of determining a CC set formed of one or more component carriers to be used by a predetermined UE from among multiple component carriers.

The CC set determining unit 410 may allow the UE to use a plurality of component carriers (CC) based on performance of hardware of a corresponding UE, available frequency resources of an eNB, and the like, and may define the CCs to be a set or a CC set. To determine a CC set to be used by a predetermined UE, measurement information measured by the UE, information fixedly set in a system stored in an internal memory of the UE, information transmitted to the UE from an eNB through system information, system information of available component carriers stored in the internal memory of the UE, and the like may be used, but this may not be limited thereto.

The search space generating unit 420 may perform a function of determining a search space corresponding to a set of control information search position candidates associated with one or more carriers allocated to a predetermined UE. In this example, a search space may be generated for each carrier, and the search space may be determined based on a function associated with a carrier indicator of a corresponding carrier, but this may not be limited thereto.

The generation of the search space may be based on Equations 1 through 3 or Equation 13 and the like, but this may not be limited thereto and the search space may be generated through other various methods.

For example, as given in Equation 9, when the search space generating unit 420 determines a search space associated with a plurality of used component carriers, the search space generating unit 420 may form, to be the search space, a CCE extended to a value obtained by multiplying carrier indicator information (for example, n_{CI} which is a carrier indicator field and the like) of a plurality of corresponding CCs from a predetermined position (m of Equation 1) and M^{(L)} indicating a number of search position candidates of a single CC. Also, as given in Equation 9, the search space associated with the plurality of component carriers may be extended to successively configured CCEs.

In other words, to extend the search space, the search space Sₖ^{(L)} may be determined through use of m+M^{(L)}·n_{CI} as opposed to using in Equation 1.

The search position determining unit 430 may perform a function of selecting and determining a search position to which control information or PDCCH information is to be actually allocated, from among a plurality of search position candidates included in the generated search space.

The search position determining unit 430 may use a first scheme that selects one or more search positions from the search space corresponding to a search position candidate (group), determined based on a function associated with a carrier indicator, and a second scheme that selects one or more search positions from an extended search position candidate (group) formed by multiplying one or more search positions applied to a single carrier and a total number of component carriers used in a system.

Also, the first scheme may include a (1-1) scheme that selects a single search position from the plurality of search position candidates (group) in the search space determined by a single carrier indicator, and a (1-2) scheme that selects two or more search positions from the plurality of search position candidates (group) corresponding to the search space determined by the single carrier indicator.

For reference, an example of the second scheme may be expressed based on Equations 9 through 12, and an example of the (1-1) scheme may be expressed based on Equations 16 through 20, and an example of the (1-2) scheme may be expressed based on Equation 21.

The control information rearranging and resource allocating unit 440 may rearrange control information or a PDCCH generated for each component carrier to be used by a corresponding UE in blind decoding order of the UE, and may allocate the rearranged control information to a corresponding search position that is a predetermined location in a resource space.

In this example, the rearrangement may enable downlink control information of a CC having the highest carrier indicator to be allocated to a search position having the earliest blind decoding order from among the plurality of determined search positions.

Also, the rearrangement may arrange control information of a predetermined carrier such as a primary carrier, to a search position having the earliest decoding order, irrespectively of a carrier indicator.

The decoding order of search positions may be determined based on a scheme in which a search position determined by a lower carrier indicator from among a plurality of component carriers used for generating a search space has an earlier decoding order, a scheme of determining a decoding order of a search position based on an order of a physical position of a control channel element (CCE) corresponding to the corresponding search position, and a scheme of determining a decoding order based on a rule for a decoding order, predetermined by a UE or an eNB, but this may not be limited thereto.

The rearranged and resource allocated control information or PDCCH information may be transmitted to the UE through a corresponding transmission channel.

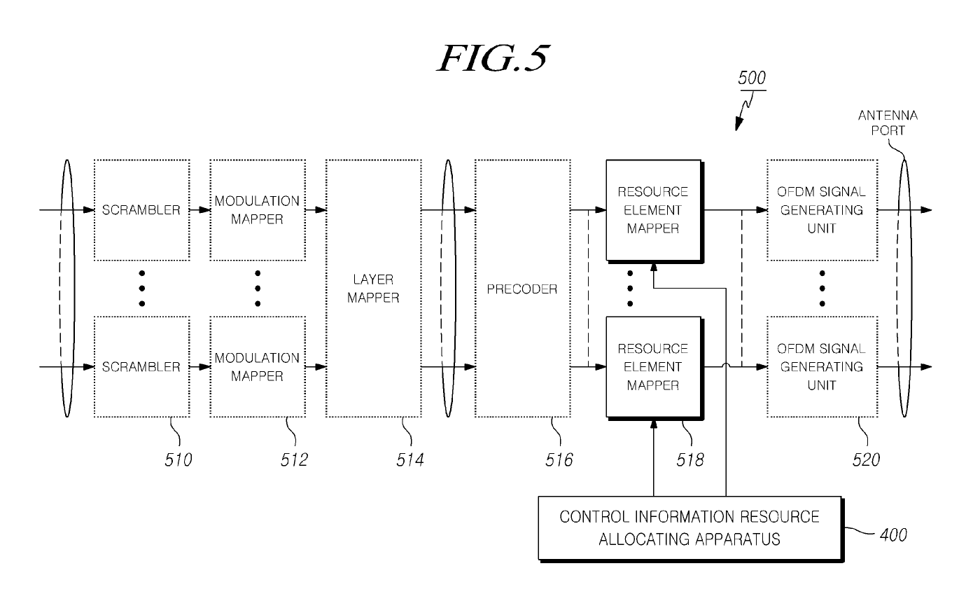

FIG. 5 is a diagram illustrating an example of a configuration of an entire transmitting apparatus including a control information resource allocating apparatus according to an embodiment of the present invention.

The entire transmitting apparatus may include an eNB and the like, but this may not be limited thereto.

According to an embodiment of the present invention, an entire transmitting apparatus 500 including a control information resource allocating apparatus may include scramblers 510, modulation mappers 512, a layer mapper 514, a precoder 516, resource element mappers 518, and OFDM signal generators 520. The entire transmitting apparatus 500 may include the control information resource allocating apparatus 400 which is described in the foregoing.

The control information resource allocating apparatus 400 may perform a function of generating control information or PDCCH information associated with each carrier, and may allocate the generated control information or the PDCCH information to a search position in a reverse order of a decoding order.

According to the general operations of the entire transmitting apparatus 500, bits that are input in a form of code words after channel coding in a downlink may be scrambled by the scrambler 510 and may be input into the modulation mapper 512. The modulation mapper 512 may modulate the scrambled bits into a complex modulation symbol, and the layer mapper 514 may map the complex modulation symbol to a single layer or a plurality of transmission layers. Subsequently, the precoder 516 may perform precoding of the complex modulation symbol in each transmission channel of an antenna port. The resource element mapper 518 may map a complex modulation symbol associated with each antenna port (antennas #1 through 8) to a corresponding resource element.

According to an embodiment of the present invention, control information or a PDCCH may be generated by the control information resource allocating apparatus 400 and may be allocated to a search position in the inverse order of a blind decoding order, and may be allocated to resource elements corresponding to a time/frequency resource space.

Although FIG. 5 illustrates that the control information resource allocating apparatus 400 is embodied separately from the resource element mapper 518, this may not be limited thereto, and the resource element mapper 518, the control information rearranging and resource allocating unit 440, and the like may be embodied as a physically integrated apparatus.

Subsequently, the OFDM signal generator 520 may generate a control signal or a PDCCH signal into a complex time domain OFDM signal, and the complex time domain OFDM signal may be transmitted through an antenna port.

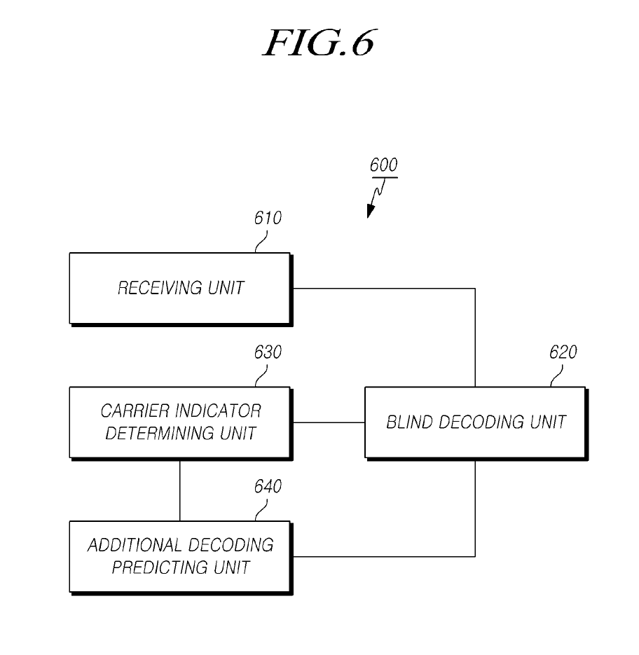

FIG. 6 is a diagram illustrating a configuration of a control information decoding apparatus according to an embodiment of the present invention.

A control information decoding apparatus 600 of FIG. 6 may be configured to include a receiving unit 610 to receive rearranged control information, a blind decoding unit 620, a carrier indicator determining unit 630, and an additional decoding predicting unit 640.

The receiving unit 610 may perform a function of receiving control information or PDCCH information that is transmitted after being rearranged in decoding order. In this example, a received signal may be a signal of which carrier control information is rearranged so that an order of carrier indicators becomes an inverse order of the blind decoding order at a receiving end, but it may not be limited thereto.

The blind decoding unit 620 may perform a function of obtaining control information or a PDCCH associated with a predetermined carrier by decoding a signal of a predetermined search position determined based on a predetermined decoding order. In this example, the decoding order may correspond to an order of search positions determined for each carrier (ascending order of carrier indicators), an order of physical search positions (an order of CCE numbers), an order arbitrarily determined by another receiving end, or an order determined by a separate signaling or a predetermined definition, but it may not be limited thereto.

The carrier indicator determining unit 630 may perform a function of determining a carrier corresponding to the decoded control information. For example, a carrier indicator of a corresponding carrier may be included in the decoded control information or PDCCH. In this example, the carrier indicator may be determined.

The additional decoding predicting unit 640 may perform a function of predicting a number of carrier control information to be additionally obtained, that is, a number of blind decodings to be additionally performed, based on information (for example, a carrier indicator) associated with the carrier corresponding to the decoded control information or PDCCH. For example, in the case where control information of a carrier having a higher indicator is allocated to a search position having an earlier decoding order as described in the foregoing, when control information decoded at the first decoding is control information associated with CC2, it is predicted that control information associated with CC1 and CC0 need to be additionally decoded, that is, the blind decoding process may be additionally performed two more times.

Subsequently, the blind decoding unit 630 may successively perform blind decoding by a number of times predicted by the additional decoding predicting unit 640 and thus, control information or PDCCHs associated with all carriers allocated to the corresponding UE may be obtained.

According to embodiments of the present invention, a number of blind decodings to be performed and the complexity of decoding may be reduced when a system that uses a plurality of component carriers transmits control information or PDCCHs of multiple carriers to a predetermined UE and the UE decodes the received control information or PDCCHs.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of determining a search space for blind decoding of downlink control information by a receiving apparatus in a communication system that uses multiple component carriers, the method comprising:
selecting a CC set including one or more component carriers to be used by the receiving apparatus; and
determining, to be the search space, an extended search candidate formed by multiplying a number of one or more search candidates applied to a single carrier and a total number of component carriers used in the system.

2. The method as claimed in claim 1, wherein the search space is formed by multiplying a number of search candidates M^{(L)} to be checked in a search space with respect to a single carrier and a total number of carriers n_{CI,max} allocated to the receiving apparatus.

3. A method of determining a search position to which downlink control information is to be allocated in a search space for blind decoding of the downlink control information by a receiving apparatus in a communication system that uses multiple component carriers, the method comprising:
selecting a CC set including one or more component carriers to be used by the receiving apparatus;
determining, to be the search space, an extended search candidate formed by multiplying a number of one or more search candidates applied to a single carrier and a total number of component carriers used in the system; and
successively determining a search position where downlink control information is to be located in the search space, by excluding a search position preoccupied (blocked) by another UE in the search space.

4. A method of decoding control information in a communication system that uses multiple component carriers, the method comprising:
receiving control information that is allocated to a search position selected from a search space formed by multiplying a number of one or more search candidates applied to a single carrier and a total number of component carriers used in a system, and is transmitted;
performing blind decoding with respect to a predetermined resource search position in decoding order; and
obtaining control information of each carrier.

5. An apparatus for determining a search space for blind decoding of downlink control information by a receiving apparatus in a communication system that uses multiple component carriers, the apparatus comprising:
a CC set determining unit to select a CC set including one or more component carriers to be used by the receiving apparatus; and
a search space generating unit to generate the search space for blind decoding of downlink control information,
wherein the search space generating unit determines, to be the search space, an extended search candidate formed by multiplying a number of one or more search candidates applied to a single carrier and a total number of component carriers used in the system.

6. An apparatus for determining a search position to which downlink control information is to be allocated in a search space for blind decoding of the downlink control information by a receiving apparatus in a communication system that uses multiple component carriers, the apparatus comprising:
a CC set determining unit to select a CC set including one or more component carriers to be used by the receiving apparatus;
a search space generating unit to generate the search space for blind decoding of downlink control information; and
a search position determining unit to determine one or more search positions extracted from the search space,
wherein the search space generating unit determines, to be the search space, an extended search candidate formed by multiplying a number of one or more search candidates applied to a single carrier and a total number of component carriers used in the system; and
the search position determining unit successively determines a search position to which downlink control information is to be located in the search space, by excluding a search position preoccupied (blocked) by another UE in the search space.

7. An apparatus for decoding control information in a communication system that uses multiple component carriers, the apparatus comprising:
a receiving unit to receive control information that is allocated to a search position selected from a search space formed by multiplying a number of one or more search candidates applied to a single carrier and a total number of component carriers used in the system, and is transmitted; and
a decoding unit to obtain control information associated with a corresponding carrier by performing blind decoding with respect to a predetermined resource search position in decoding order.

8. A method of allocating downlink control information to a resource space in a communication system that uses multiple component carriers, the method comprising:
selecting a CC set including one or more component carriers to be used by a predetermined UE;
determining a search space for blind decoding of downlink control information;
determining one or more search positions extracted from the search space; and
rearranging downlink control information associated with at least a few of the component carriers included in the CC set and allocating the rearranged downlink control information to the plurality of search positions.

9. The method as claimed in claim 8, wherein the rearrangement allocates downlink control information of a component carrier having a higher carrier indicator to a search position having an earlier blind decoding order from among the one or more search positions.

10. The method as claimed in claim 8, wherein determining of the plurality of search positions is performed based on one of:
a first scheme that selects one or more search positions to which the downlink control information is to be allocated, from the search space corresponding to a set of search position candidates, determined based on a function associated with a carrier indicator; and
a second scheme that selects one or more search positions from an extended search candidate formed by a number of one or more search positions applied to a single carrier and a total number of component carriers used in a system.

11. The method as claimed in claim 10, wherein the first scheme comprises:
a (1-1) scheme that selects a single search position from the one or more search position candidates in the search space determined by a single carrier indicator; and
a (1-2) scheme that selects two or more search positions from the plurality of search position candidates in the search space determined by the single carrier indicator.

12. The method as claimed in claim 8, wherein a search position determined by a lower carrier indicator from among the one or more component carriers used for generating the search space has an earlier decoding order.

13. The method as claimed in claim 8, wherein decoding order associated with the search position is determined based on a physical order of a control channel element (CCE) corresponding to the search position.

14. The method as claimed in claim 9, wherein downlink control information of a predetermined component carrier from among the one or more component carriers included in the CC set or downlink control information of a predetermined component carrier set is allocated to a search position having the highest or the lowest decoding order, irrespective of large or small of the carrier indicator.

15. A method of determining a search space that is a set of physical downlink control channel (PDCCH) candidates to be monitored by a user equipment in a communication system that uses multiple component carriers, the method comprising:
when the user equipment uses the plurality of component carriers, determining, to be the search space, an extended search candidate formed by multiplying a number of one or more search candidates applied to a single carrier and carrier indication information of a component carrier formed in the user equipment.

16. The method as claimed in claim 15, wherein the carrier indication information of the component carrier formed in the user equipment is a carrier indicator field value n_{CL}; and
the search space is determined based on a value obtained by multiplying a number of search candidates M^{(L)} to be checked in the search space with respect to a single carrier and the carrier indicator field value n_{CL}.
